(19) United States
(12) Patent Application Publication
(10) Pub. No.: US 2007/0081101 A1
(43) Pub. Date: Apr. 12, 2007

(54) Automatic display adaptation to lighting

(75) Inventors: Elmo M.A. Diederiks, Eindhoven (NL); Marcel Jean Godfroy, Brugge (BE)

Correspondence Address: PHILIPS INTELLECTUAL PROPERTY & STANDARDS, P.O. BOX 3001, BRIARCLIFF MANOR, NY, 10510, US

(73) Assignee: T-MOBILE DEUTSCHLAND GMBH, BONN GERMANY (DE)

(21) Appl. No.: 10/577,396

(22) PCT Filed: Oct. 25, 2004
(86) PCT No.: PCT/IB04/52196

§ 371 Date: Apr. 27, 2006

Related U.S. Application Data
(60) Provisional application No. 60/514,703, filed on Oct. 27, 2003.

(51) Int. Cl. H04N 5/44

(52) U.S. Cl. 348/602; 348/553

(57) ABSTRACT

A method for viewing images on a display (100, 110) is provided. The method includes producing a lighting effect to enhance the viewing of the images on the display and automatically adjusting one or more display settings of the display based on the produced lighting effect. The display can be a television and the lighting effect can be produced by a light source (102) integrated in the television or separable (116, 132) therefrom. The one or more display settings can be selected from a group consisting of contrast, hue, saturation, color temperature, and brightness.

The present invention relates generally to displays which utilizes light sources for enhancing a viewing experience of images and/or video on the display, and more particularly, to displays such as monitors and televisions which have an integrated light source to enhance a viewing experience and to automatically adjust display settings of the display based on the output of the light source.

It is known in copending applications to utilize a light source with a television or other display and to use the light source to enhance the viewing experience of watching a film or listening to music by means of altering the lighting atmosphere and/or creating lighting effects. However, when such lighting is integrated into the display or otherwise used in connection with the display, the lighting itself can influence the perception of the images and video content rendered in the display itself.

Therefore it is an object of the present invention to provide methods and systems that overcome these and other disadvantages associated with the prior art.

Accordingly, a method for viewing images on a display is provided. The method comprising: producing a lighting effect to enhance the viewing of the images on the display; and automatically adjusting one or more display settings of the display based on the produced lighting effect.

The display can be a television and the lighting effect can be produced by a light source integrated in the television. The display can be a television and the lighting effect can be produced by a light source separable from the television.

The one or more display settings can be selected from a group consisting of contrast, hue, saturation, color temperature, and brightness.

The producing can comprise increasing a light intensity and the automatically adjusting can comprise automatically adjusting a contrast of the display.

Also provided is a display for viewing images. The display comprising: a display portion for rendering the images; an integrated light source for producing a lighting effect to enhance the viewing of the images on the display; and a processor for automatically adjusting one or more display settings of the display based on the produced lighting effect. The display can be a television. The one or more display settings can be selected from a group consisting of contrast, hue, saturation, color temperature, and brightness. The integrated light source can increase a light intensity and the processor can automatically adjust a contrast of the display portion.

Still provided is a system for viewing images. The system comprising: a display for rendering the images on a display portion; a light source for producing a lighting effect to enhance the viewing of the images on the display; and a processor for automatically adjusting one or more display settings of the display based on the produced lighting effect.

The display can be a television and the light source can be integrated in the television. In which case, the processor can be integral with the television.

The display can be a television and the light source can be separable from the television. In which case, the processor can be separable from the television. Where the light source and processor are separable from the television, the light source and processor can be contained in a set-top box operatively connected to the television.

The one or more display settings can be selected from a group consisting of contrast, hue, saturation, color temperature, and brightness. Where the light source increases a light intensity, the processor can automatically adjust a contrast of the display portion.

Still yet provided is a set-top box for use with a television. The set-top box comprising: a light source for producing a lighting effect to enhance viewing of images on the television; and a processor operatively connected to the light source and television for automatically adjusting one or more display settings of the television based on the produced lighting effect. The light source can be integral with the set-top box.

Also provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

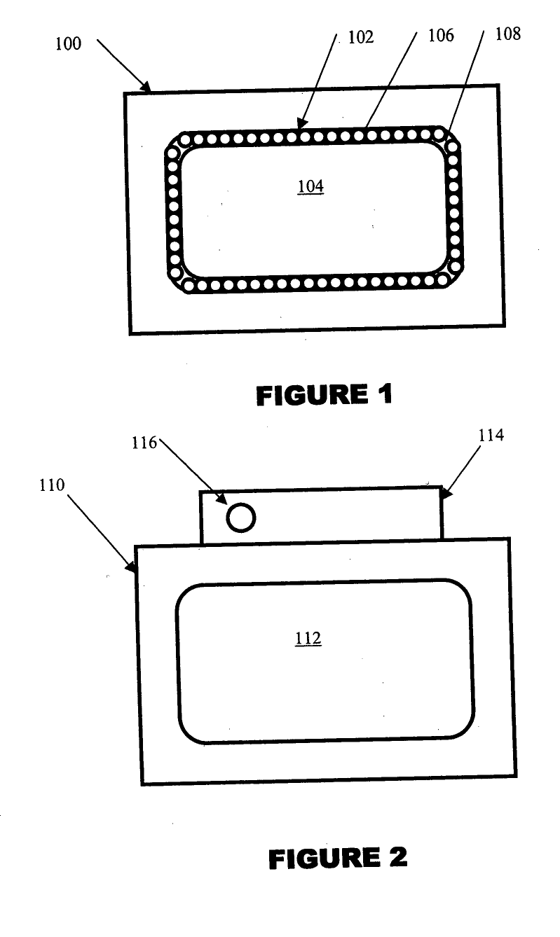

FIG. 1 illustrates a display having an integrated light source.

FIG. 2 illustrates a display operatively connected to a set-top box, the set-top box having a light source.

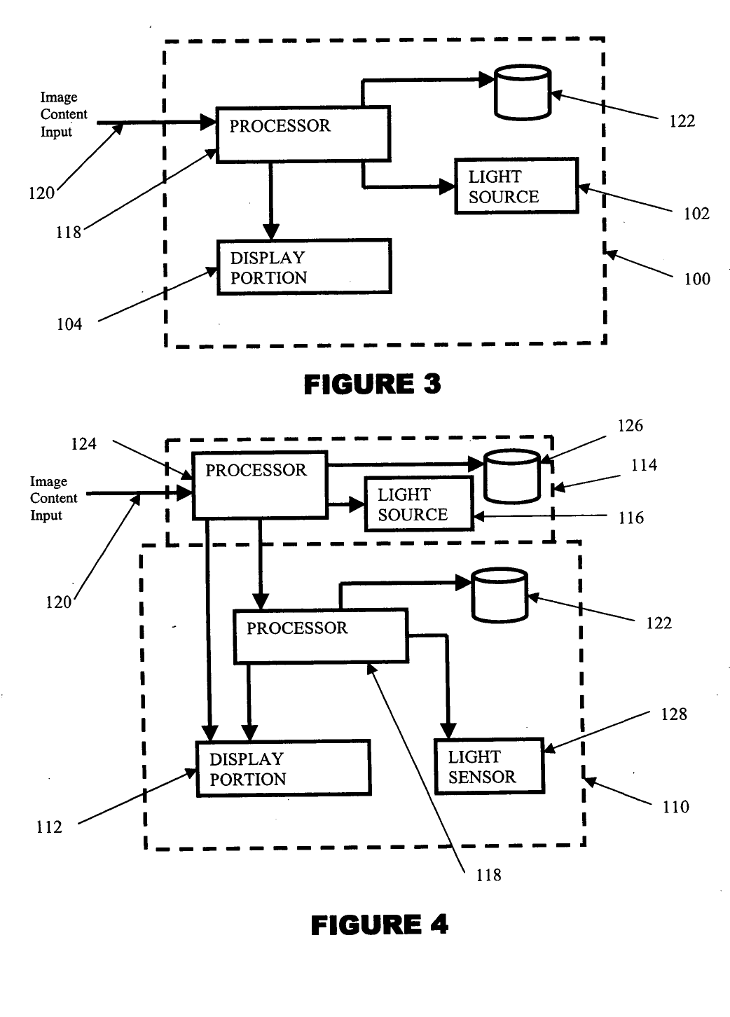

FIG. 3 illustrates a schematic diagram of the display of FIG. 1.

FIG. 4 illustrates a schematic diagram of the display and set-top box of FIG. 2.

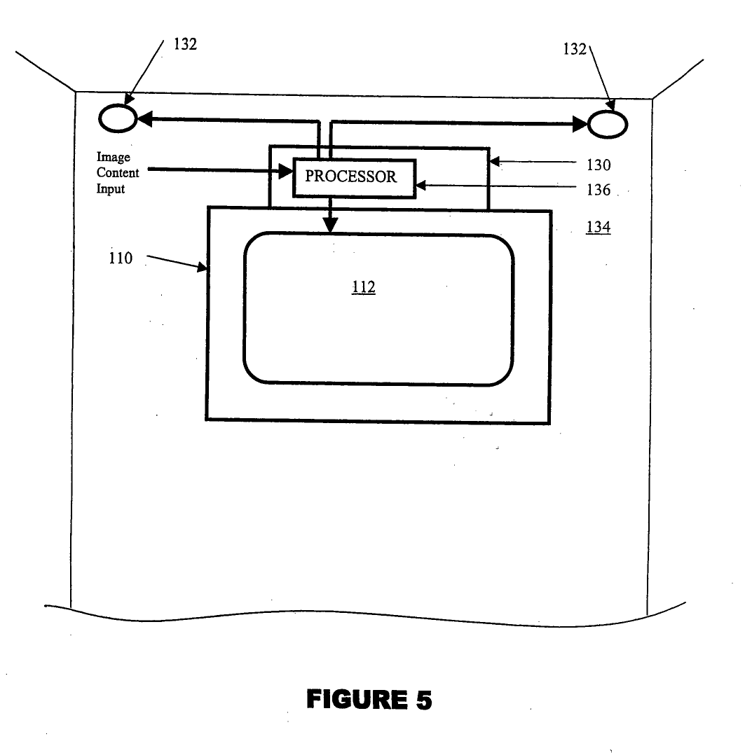

FIG. 5 illustrates a system having a display, set-top box and wall mounted light sources.

Although this invention is applicable to numerous and various types of displays and light sources, it has been found particularly useful in the environment of televisions with integrated light sources. Therefore, without limiting the applicability of the invention to televisions with integrated light sources, the invention will be described in such environment. However, those skilled in the art will appreciate that the displays of the present invention can be other types of monitors and the light source can be separable therefrom.

Referring now to FIG. 1, there is shown a display 100, in the form of a television. The television 100 has an integrated light source 102 which can surround the display portion 104 of the television. The integrated light source 102 can be a series of LEDs 106 disposed in a frame 108 around the display portion 104. The display portion 104 displays a rendering of images and/or video content (collectively referred to herein as “images” or “image content”). The light source 102 is used to enhance a viewing experience of the images rendered on the display portion 104 of the television 100 as discussed in co-pending Netherlands Patent Applications NL020627, NL020628, and NL020607, the contents of each of which are incorporated herein in their entirety by their reference. The light source 102 can enhance the viewing experience of the images rendered on the display portion 104 of the television 100 by altering the ambient lighting conditions and/or creating lighting effects (collectively referred to herein as “lighting effects”). As discussed above, while such methods and apparatus enhance the viewing experience of the images rendered on the display portion 104 of the television 100, the lighting itself can influence the perception of the images rendered in the display portion 104.

Referring now to FIG. 2, there is shown a television 110 having a display portion 112 for rendering the images. A set-top box 114 is provided and operatively connected to the television 110, such as to provide the image content to the television 110. The set-top box 114 can be any device used in connection with a television, such as a personal video recorder (PVR), a VCR, a DVD player, and a tuner such as a cable tuner. In the embodiment of FIG. 2, the light source 116 is integrated into the set-top box 114 and is used for the same purposes as discussed above with regard to the integrated light source 102, namely, to enhance the viewing experience of the images rendered on the display portion 112 of the television 110.

Referring now to FIG. 3, there is illustrated a schematic of the television 100 of FIG. 1. The television 100 includes a processor 118 for receiving an image content input signal 120 and supplying the same to the display portion 104 for rendering corresponding images on the display portion 104. Thus, the display portion 104 is under the control of the processor 118. Of course, the processor can format, de-multiplex, and otherwise condition the signal 120 such that it is compatible with the display portion 104. The television 100 further has a storage device 122 operatively connected to the processor 118 for storing settings and program instructions for carrying out the normal operation of the television, for control of the light source, as well as for carrying out the methods of the present invention as will be discussed fully below. Although, shown as a single storage device, those skilled in the art will appreciate that the storage device 122 can be implemented in two or more storage devices and such storage devices can be of any type known in the art for storing data. The light source 102 is also under the control of the processor 118 and is controlled according to a set of instructions contained on the storage device 122 to enhance the viewing experience of the images rendered on the display portion 104.

Referring now to FIG. 4, there is illustrated a schematic of the television and set-top box of FIG. 2. The set-top box includes a processor 124 for receiving the image content input signal 120 and supplying the same to the display portion 112 for rendering corresponding images on the display portion 104. As discussed above, the processor 124 can format, de-multiplex, and otherwise condition the signal 120 such that it is compatible with the display portion 112. The set-top box 114 further has a storage device 126 operatively connected to the processor 124 for storing settings and program instructions for carrying out the normal operation of the set-top box 114, for control of the light source, as well as for carrying out the methods of the present invention as will be discussed fully below. Although, shown as a single storage device, those skilled in the art will appreciate that the storage device 126 can be implemented in two or more storage devices and such storage devices can be of any type known in the art. The light source 116 is also under the control of the processor 126 and is controlled according to a set of instructions contained on the storage device 126 to enhance the viewing experience of the images rendered on the display portion 112.

Alternatively, the processor 118 of the television 110 can receive the image content input signal 120 from the set-top box 114 and supply the same to the display portion 112 for rendering corresponding images on the display portion 112. Thus, the display portion 112 can be under the control of either the processor 124 of the set-top box 114 or the processor 118 of the television 110. The storage device 122 of the television 110 is operatively connected to the processor 118 for storing settings and program instructions for carrying out the normal operation of the television. As will be discussed below, the processor 118 can also carry out the methods of the present invention when used with a lighting sensor 128 operatively connected thereto.

Referring now to FIG. 5, there is illustrated a television 110 and set-top box 130 similar to those shown and described with respect to FIGS. 2 and 4. However, instead of the light source(s) 132 being integral with the set-top box 130, they are mounted on a wall 134 proximate the television 110. The light sources 132 are operatively connected to the set-top box 130 and under the control of its processor 136 to enhance the viewing experience of the images rendered on the display portion 112 of the television 110.

The methods of the present invention will now be described with reference to FIGS. 1-5. As discussed above, the light sources 102, 116, 132 can enhance the viewing experience of the images rendered on the display portion 104, 112 of the television 100, 110 by altering the ambient lighting conditions and/or creating lighting effects (collectively referred to herein as “lighting effects”). However, the light source 102, 116, 132 can influence the perception of the images rendered in the display portion 104, 112. Thus, the processor 118, 124, detects the produced lighting effect of the light source 102, 116, 132 and automatically adjusts one or more display settings of the display portion 104, 112 based on the produced lighting effect. The one or more display settings can be contrast, hue, saturation, color temperature, and brightness. For example, where the light source 102, 116, 132 increases an ambient light intensity, the increase in light intensity causes the processor 118, 124 to automatically adjust a contrast of the display portion 104, 112 to increase the contrast. In another example, the light source 102, 116, 132, by means of RGB and amber LED's, can alter the color of the ambient lighting. In response, the processor 118, 124 can automatically adapt the color change in the images rendered on the display portion 104, 112 by adjusting the hue, saturation, and/or color temperature settings of the display portion 104, 112 accordingly.

In the configurations of FIGS. 3-5, the adjustment in the display settings are preferably relayed to the television processor 118 and carried out by the processor 118 internal to the television 110. However, the processor 124 of the set-top box 114, 130 can also directly control the display settings of the display portion 112. The control of the display settings can be based on values in a look-up table for different produced lighting effects or it can be based on an algorithm that takes into account different lighting effect characteristics.

The lighting effect and its characteristics are preferably controlled by the same processor 118, 124 which carries out the adjustment in the display settings of the display portion 104, 112, therefore, the produced lighting effect is fed directly to the algorithm or look up table to determine the adjustment in the display settings, if any. However, where a first processor (e.g., 124) controls the lighting effect and a second processor (e.g., 118) controls the adjustment in display settings, the first processor can communicate with the second processor to supply the lighting effect produced. The second processor can then determine the adjustment to the display settings based on the lighting effect produced. The first processor can also supply a desired adjustment in the display settings to the second processor, in which case the second processor merely carries out such an adjustment. Alternatively, the processor 118 of the television can carry out the adjustment to the display settings without communication of the same from the processor 124 of the set-top box 114 by use of the lighting sensor 128. The lighting sensor can be used to determine the ambient lighting conditions produced by the light sources 102, 116, 130 (and any other external light sources such as regular room or natural lighting) and determine any adjustment in the display settings of the display portion 112. Furthermore, the lighting sensor 128 can be used only to determine the lighting effect from external sources (external to the light sources 102, 116, 130) such as regular room lighting and natural sources to adjust the adjustment in the display settings based only on the produced lighting effects by the light sources 102, 116, 130. That is, the processor 118, 124 can determine an adjustment to the display settings based on a produced lighting effect and that adjustment can itself be adjusted based on the lighting conditions detected at the lighting sensor 128 (which could only be the difference between the produced lighting effect and any external lighting sources such as natural sources and regular room lighting).

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for viewing images on a display (100, 110), the method comprising:
producing a lighting effect to enhance the viewing of the images on the display; and
automatically adjusting one or more display settings of the display based on the produced lighting effect.

2. The method of claim 1, wherein the display is a television (100, 110) and the lighting effect is produced by a light source (102) integrated in the television.

3. The method of claim 1, wherein the display is a television and the lighting effect is produced by a light source separable (116, 132) from the television.

4. The method of claim 1, wherein the one or more display settings are selected from a group consisting of contrast, hue, saturation, color temperature, and brightness.

5. The method of claim 1, wherein the producing comprises increasing a light intensity and the automatically adjusting comprises automatically adjusting a contrast of the display.

6. A display (100) for viewing images, the display comprising:
a display portion (104) for rendering the images;
an integrated light source (102) for producing a lighting effect to enhance the viewing of the images on the display; and
a processor (118) for automatically adjusting one or more display settings of the display based on the produced lighting effect.

7. The display of claim 6, wherein the display is a television.

8. The display of claim 6, wherein the one or more display settings are selected from a group consisting of contrast, hue, saturation, color temperature, and brightness.

9. The display of claim 6, wherein the integrated light source increases a light intensity and the processor automatically adjusts a contrast of the display portion.

10. A system for viewing images, the system comprising:
a display (100, 110) for rendering the images on a display portion (104, 112);
a light source (102, 116, 132) for producing a lighting effect to enhance the viewing of the images on the display; and
a processor (118, 124, 136) for automatically adjusting one or more display settings of the display based on the produced lighting effect.

11. The system of claim 10, wherein the display is a television and the light source (102) is integrated in the television.

12. The system of claim 11, wherein the processor is integral (118) with the television.

13. The system of claim 10, wherein the display is a television and the light source (116, 132) is separable from the television.

14. The system of claim 13, wherein the processor (124, 136) is separable from the television.

15. The system of claim 14, wherein the light source and processor are contained in a set-top box (114) operatively connected to the television.

16. The system of claim 10, wherein the one or more display settings are selected from a group consisting of contrast, hue, saturation, color temperature, and brightness.

17. The system of claim 10, wherein the light source increases a light intensity and the processor automatically adjusts a contrast of the display portion.

18. A set-top box (114) for use with a television, the set-top box comprising:
a light source (116, 132) for producing a lighting effect to enhance viewing of images on the television; and
a processor (124) operatively connected to the light source and television for automatically adjusting one or more display settings of the television based on the produced lighting effect.

19. The set-top box of claim 18, wherein the light source (102) is integral with the set-top box.

20. A computer program product embodied in a computer-readable medium for viewing images on a display (100, 110), the computer program product comprising:
computer readable program code means for producing a lighting effect to enhance the viewing of the images on the display; and
computer readable program code means for automatically adjusting one or more display settings of the display based on the produced lighting effect.

21. (canceled)

22. The method according to claim 1, wherein a program storage device readable by machine, tangibly embodies a program of instructions executable by the machine to perform the method steps for viewing images on the display (100, 110).
